(19) United States
(12) Patent Application Publication
(10) Pub. No.: US 2015/0111404 A1
(43) Pub. Date: Apr. 23, 2015

(54) Remotely installed fire and smoke detector

(71) Applicant: Ronald F. Seiler, N. Fort Myers, FL (US)

(72) Inventor: Ronald F. Seiler, N. Fort Myers, FL (US)

(21) Appl. No.: 13/998,315

(22) Filed: Oct. 21, 2013

(51) Int. Cl. H01R 31/00; H01R 31/06; H01R 43/26

(52) U.S. Cl. CPC H01R 31/005; H01R 43/26; H01R 31/06
USPC 439/170; 29/747

(57) ABSTRACT

A fire and smoke detector consisting of a base unit and a bottom unit that are connected to each other. The base unit has female connectors thereon that have a metal cladding thereon which are connected to their respective wires coming from the electrical box on which the base unit is installed. The bottom unit has the corresponding male connectors thereon which also have a metal cladding thereon. An electric circuit is established when the male and female connectors are attached to each by way of a rotation. The rotation is achieved in a remote manner by using a person manipulated elongated pole that has outwardly extending prongs thereon that engage peripheral depressions on the base unit. By twisting the installation pole, the base and the bottom unit are connected to each other because the male and female connectors engage each othe and also establish an electric circuit.

### BACKGROUND OF THE INVENTION

Fire and smoke alarm detectors are normally installed by climbing a ladder and make the necessary wire connections to existing wires that are contained in an electrical box mounted in the ceiling. There is normally a base element which is mounted on the ceiling in front of the electrical box. Once the necessary wire connections are made, the detecting unit is mounted over the base element by way of screws.

### BRIEF DESCRIPTION OF THE INVENTION

The inventive concept makes it much easier to install the fire and smoke detector. First of all the basic unit is mounted against the ceiling. The basic unit has a female metal dove and tail connector thereon and the corresponding wires are connected to this type of connection. The fire and smoke detector unit has the opposite metal male dove and tail connections thereon. When the two connecting dove and tail connections are made, the detector is properly wired for its operation, that is, to signal any fire and smoke environment in its vicinity. The fire and smoke detector unit further has been modified to be installed remotely without the use of a ladder. This unit has on its surface at least three apertures which are accessible by way of a three prong installing device. The at least three prongs are mounted at the end of a long hand held pole which is held by a person on the floor of room were the detector is installed. It s merely up to the person to engage the at least three apertures in the bottom unit, turn it to disengage the dove and tail connectors, and then remove the bottom unit for service. To install the bottom unit is exactly the reverse of the demonstrated removal.

### BRIEF DESCRIPTION OF THE DRAWINGS

FIG. 1 is a perspective view of the basic unit which is to be mounted onto the ceiling over the electrical box (not shown);

FIG. 2 illustrates the lower unit to be mounted on the basic unit;

FIG. 3 illustrates a bottom view of the lower unit;

FIG. 4 shows how the lower unit is mounted onto the upper unit by way of a remote pole system;

FIG. 5 shows the top of the mounting pole of FIG. 4 having a cap thereon with outwardly extending mounting prongs;

FIG. 6 illustrates the means for connecting the base unit and the lower together prior to completion;

FIG. 7 shows both units in a connected state.

### DETAILED DESCRIPTION OF THE INVENTION

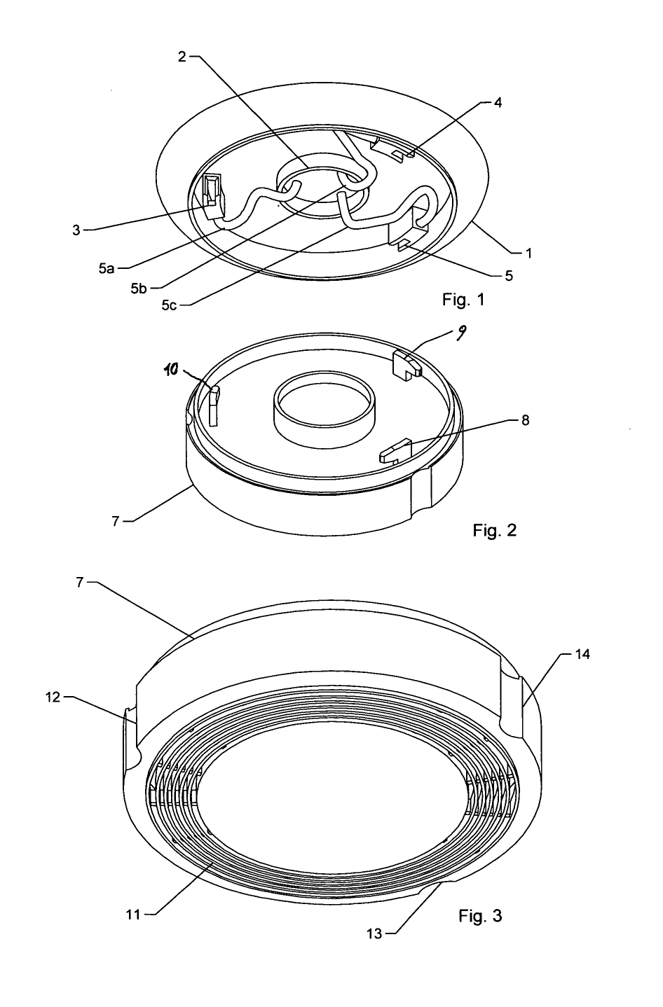

FIG. 1 shows the basic unitl in a perspective view which is to be mounted over an electrical box in the ceiling. This is a common practice. The wires 5a, 5b, and 5c coming out of the electrical box (not shown) are connected to their respective female connectors 3, 4, and 5. The basic unit has a center opening 2. The wires 5a, 5b, and 5c are usually colored as white, red and black for easy identification.

FIG. 2 illustrates the lower unit 7 which is to be mounted over the basic unit by way of the male connectors 8, 9 and 10. The detailed connection is shown in FIGS. 7 and 8. The male connectors 8, 9, and 10 are metal connectors and so are the female connectors 3, 4, and 5 in the base unit. Once they are connected they convey the electricity into the lower base which contains the elements which will sense either smoke or heat to activate an alarm. This feature is well known and, therefore, not shown.

FIG. 3 is a view of the bottom of the lower unit including the screen which allows the heat and smoke to pass there through into the lower unit. At the periphery of the basic unit there are shown three depressions 12, 13, and 14 which are instrumental in mounting the lower unit to the base unit as will be explained below in greater detail.

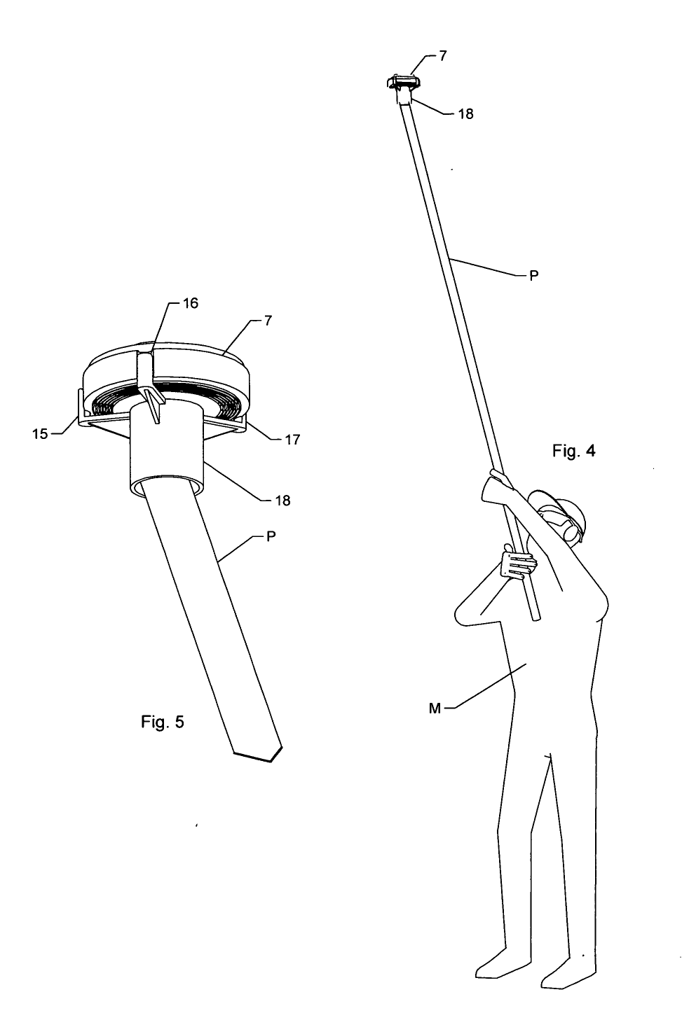

FIG. 4 shows the manner by which the lower unit is mounted remotely to the base unit. There is shown a man M manipulating a long pole P having a cap 18 at its upper end and showing a simulated lower unit 7 thereon.

FIG. 5 shows the details of the upper cap 18 mounted to the upper end of the pole P. The cap has at least three prongs 15, 16, and 17 extending outwardly there from which will engage the depressions 12, 13, and 14 shown in FIG. 3 so that it can be extended upwardly by the pole P. When placed on the base unit, a twist of the pole P will engage the respective connectors to finish the installation.

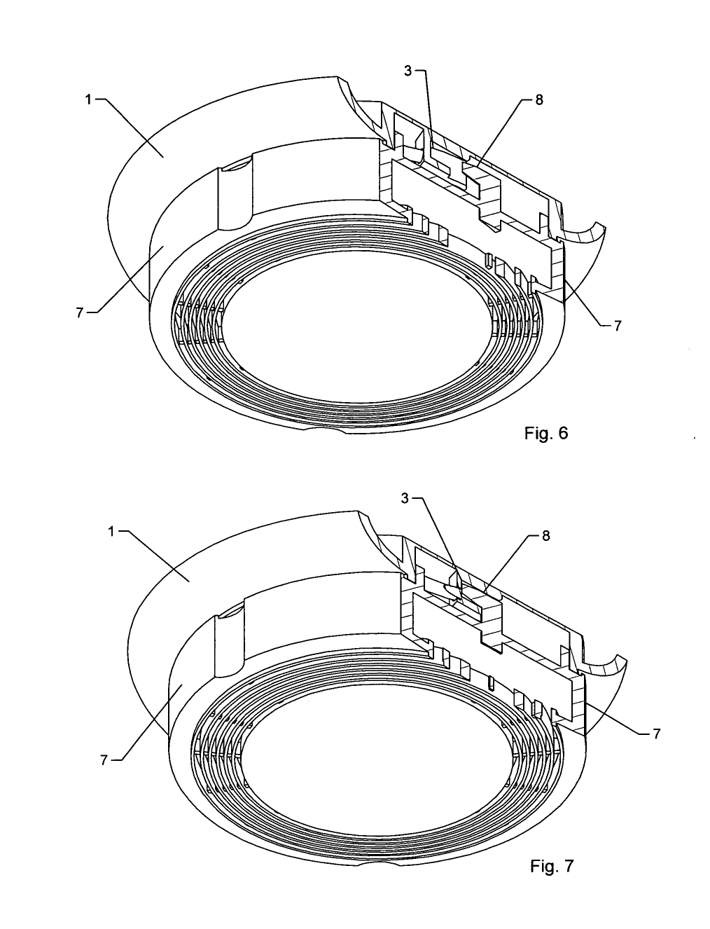

FIG. 6 shows the base unit 1 and the lower unit 7 just prior to their engagement. The base unit has three metal clad female connectors 3 (only one is shown in this FIG. 6, while all three are shown in FIGS. 1 as 2, 4, and 5). As mentioned above, the female connectors are connected to the incoming wires from the electrical box. Also shown in FIG. 6 are the metal clad male connectors 8. Again, FIG. 2 shows all three male connectors 8, 9, and 10.

FIG. 7 shows the final connections between the base unit 1 and the lower unit 7 with the female and male connectors in full engagement. As mentioned above, the final connection is achieved when the pole P with the lower unit at its top is twisted to complete the installation.

What I claim is:

1. An installation of a fire and smoke alarm device including a base unit to be mounted on a ceiling, said base unit having at least three female connectors connected with the basic wiring attached to each of said female connectors, a bottom unit attached to the base unit, means for remotely installing said bottom unit to said base unit.

2. The installation of claim 1, wherein said means for remotely installing consists of a hand manipulated pole, said pole having at its upper end a cap having outwardly extending prongs thereon.

3. The installation of claim 2, wherein said prongs engage peripheral depression on said base unit.

4. The installation of claim 1, wherein said bottom unit has male connectors thereon which engage said female connectors by way of rotation of said bottom unit.

5. The installation of claim 1, wherein said female connectors have metal cladding thereon.

6. The installation of claim 4, wherein said male connectors have metal cladding thereon which engage said metal cladding on said female connectors.
